(19) United States
(12) Patent Application Publication
(10) Pub. No.: US 2004/0176707 A1
(43) Pub. Date: Sep. 9, 2004

(54) Corrector for inverted nipple

(76) Inventor: Woul-Sun Park, Dunsang-dong Susung-gu Daegu (KR)

Correspondence Address: BLANK ROME LLP, 600 NEW HAMPSHIRE AVENUE, N.W., WASHINGTON, DC, 20037, US

(21) Appl. No.: 10/482,479

(22) PCT Filed: Aug. 24, 2001
(86) PCT No.: PCT/KR01/01428

(51) Int. Cl. A61H 7/00

(52) U.S. Cl. 601/6; 601/14

(57) ABSTRACT

Disclosed is a corrector for an inverted nipple comprising an absorption part, a nipple mould for receiving the nipple, and a narrow neck part, which obviates the need for a surgical operation or other procedures, thereby being conveniently worn by users. The corrector comprises the nipple mould for receiving the nipple protruding from the center of the breast, the narrow neck part for pressing the border line between the nipple and the mammary areola and maintaining a pressure of the inside of the nipple mould, and the absorption part for contacting the center of the breast so as to maintain the vacuum state of the corrector, wherein the narrow neck part includes a supporting element, a hollow core, and a pressing element so as to improve a holding force of the nipple by the corrector, and the absorption part includes an inclined end at a designated obtuse inside angle so as to improve a contact force of the absorption part with the breast.

### TECHNICAL FIELD

The present invention relates to a corrector for an inverted nipple, and more particularly to a corrector for an inverted nipple comprising an absorption part, a nipple mould for receiving the nipple, and a narrow neck part, which obviates the need for a surgical operation or other procedures, thereby being conveniently worn by users.

### BACKGROUND ART

Generally, nipples are protruded from a mammary areola, and there is a difference of a degree of protruding of the nipples from the mammary areola among individuals according to age and parity, i.e., in the range of 2-3 mm to 1 cm.

Inverted nipples are a common problem in which nipples are depressed into a surface of breast, and which is caused by immaturity and agenesis of mammary gland and lactiferous duct for secreting milk. It has been researched that approximately 7% of Korean women have inverted nipples.

The inverted nipples are bad in appearance, and excreta piled up on the inverted nipple smell bad. Thereby, the inverted nipples are easily infected. Particularly, in case the breast is swollen by means of an influence of hormone after parturition, the nipple is further hidden into the swollen breast, thereby causing a difficulty during lactation.

In order to solve the above-described problems caused by the inverted nipple, several methods have been conventionally used. For example, the inverted nipple is drawn out from the breast by hands, or is sucked by means of a breast pump. Further, the inverted nipple is drawn out by a surgical operation. However, the aforementioned methods are all troublesome, and in particular, the surgical operation substantially imposes a heavy burden to a patient.

Therefore, the present inventor already disclosed a corrector for an inverted nipple by Korean Utility Model Publication No. 1996-61769.

The corrector for an inverted nipple comprises an absorption part, a nipple mould for receiving a nipple, a narrow neck part, and a drawing-out loop installed on the nipple mould. The absorption part is pot-shaped with a designated curvature and connected to the nipple mould by the narrow neck part. The drawing-out loop is installed on the nipple mould.

The above conventional corrector for an inverted nipple has several problems as follows:

First, an inverted nipple is drawn into the nipple mould by a negative pressure and then the drawn nipple must be maintained within the nipple mould. However, the nipple mould has a poor force for holding the drawn nipple, thereby being difficult in continuously producing a suction effect on the inverted nipple.

Second, the drawing-out loop installed integrally with the top portion of the nipple mould serves to drawn out the nipple from the breast into the nipple mould. The drawing-out loop causes a user to feel uncomfortable in wearing the corrector. Further, since the nipple can be drawn into the nipple mould by hand-touching the mould by means of an elastic restoring force of the pressed mould, the drawing-out loop is unnecessary.

Third, a bottom portion of the absorption part is circular-shaped with a designated curvature so as to closely contact the curvaceous breast. However, the absorption part may be easily separated from the breast by a small external force during use.

### SUMMARY OF THE INVENTION

Therefore, the present invention has been made in view of the above problems, and it is an object of the present invention to provide an improved corrector for an inverted nipple comprising a narrow neck part for easily drawing the nipple into a nipple mould and improving a contact force of the nipple with the nipple mould in a vacuum state.

It is another object of the present invention to provide a corrector for an inverted nipple comprising an absorption part with an inclined end at a designated angle so as to closely contact the curvaceous breast, thereby maintaining the contact with the breast when the nipple is sucked into the nipple mould and supported by the narrow neck part.

In accordance with the present invention, the above and other objects can be accomplished by the provision of a corrector for an inverted nipple comprising a nipple mould for receiving a nipple drawn out from a center of the breast, a narrow neck part for contacting the border line between the nipple and the mammary areola and maintaining a pressure of the inside of the nipple mould, and an absorption part for contacting the center of the breast and withdrawing air therefrom, wherein the narrow neck part includes a supporting element, a hollow core, and a pressing element so as to improve a holding force of the nipple by the nipple mould, and the absorption part has an inclined end at a designated obtuse angle so as to improve a contact force of the absorption part with the breast.

The supporting element and the pressing element of the narrow neck part are be formed as protrusions from the inner circumference of the hollow core so as to hold the side surface of the nipple, thereby maintaining the pressure between the nipple and the corrector, and improving the contact force of the corrector with the breast. Preferably, the pressing element may be formed as the protrusion thicker than the supporting element so as to improve a holding force of the nipple by the corrector.

The hollow core is disposed between the supporting element and the pressing element, and forms a space for producing a suction effect between the nipple and the corrector by means of an elastic force of the corrector, thereby allowing the nipple to be sucked into the nipple mould. The hollow core serves to improve the holding force of the nipple by the corrector. Preferably, in order to improve an elastic restoring effect, contact areas between the hollow core and the supporting element and between the hollow core and the pressing element are thinner than other areas of the hollow core.

The absorption part is conical-shaped and has the inclined end at a designated obtuse angle so as to prevent the depreciation of the contact force of the absorption part with the breast due to the movement of the breast, and improve the flexibility of the absorption part of the corrector.

The inclined end of the absorption part increases a contact area of the absorption part with the breast, thereby improving the contact force of the absorption part with the breast, and is used to separate the corrector from the breast by slightly lifting up the inclined end of the absorption part.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a corrector for an inverted nipple in accordance with the present invention;

FIG. 2 is a cross-sectional view of the corrector for an inverted nipple in accordance with the present invention;

FIG. 3 is an enlarged view of an inclined end of an absorption part of the corrector for an inverted nipple in accordance with the present invention; and

FIGS. 4A and 4B are schematic views showing an operation of the corrector for an inverted nipple in accordance with the present invention.

### DETAILED DESCRIPTION OF THE PREFERRED EMBODIMENTS

Now, preferred embodiments of the present invention will be described in detail with reference to the annexed drawings.

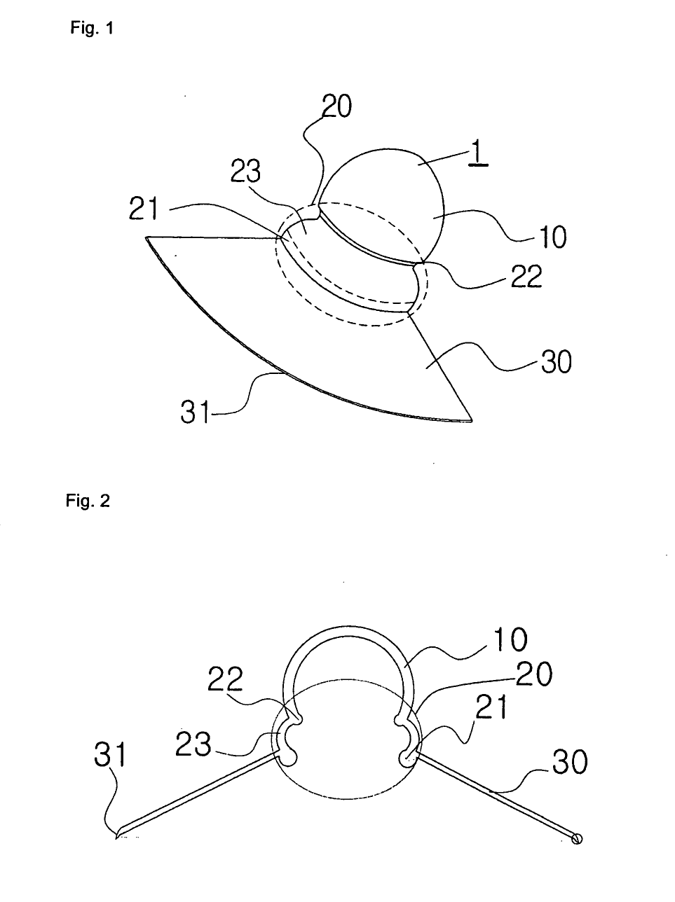

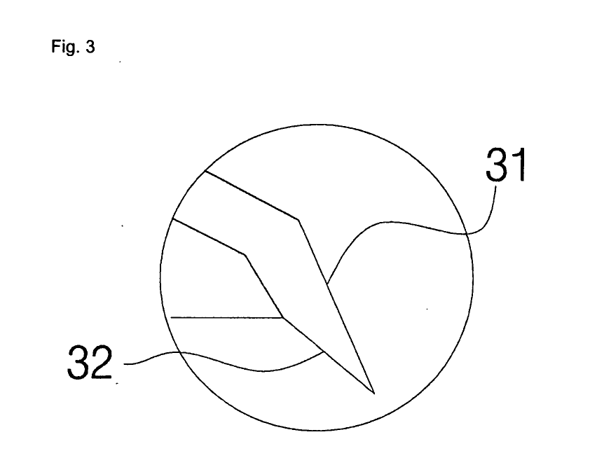

FIGS. 1 and 2 are respectively a perspective view and a cross-sectional view of a corrector for an inverted nipple in accordance with the present invention.

The corrector for an inverted nipple of the present invention comprises a nipple mould 10, a narrow neck part 20, and an absorption part 30. The nipple mould 10 serves to receive a nipple 52 protruding from the breast, and the narrow neck part 20 includes a pressing element 21, a supporting element 22, and a hollow core 23.

The supporting element 22 and the hollow core 23 hold the side surface of the nipple 52, and the pressing element 21 holds the border line between the nipple 52 and the mammary areola, when the nipple 52 is sucked into the nipple mould 10, thereby maintaining a close contact between the corrector of the present invention and the nipple 52.

The absorption part 30 is connected to the narrow neck part 20, and conical-shaped with a circular cross-section. In consideration of the close contact with the breast, the absorption part 30 includes an inclined end 31 at an obtuse angle.

The size of the absorption part 30, i.e., a length from the narrow neck part 20 to the inclined end 31 of the absorption part 30, is variable.

The size of the absorption part 30 is very important and sensitive to users. Therefore, preferably, the size of the absorption part 30 may be selected from the range of approximately 50 mm to 2 mm by the users.

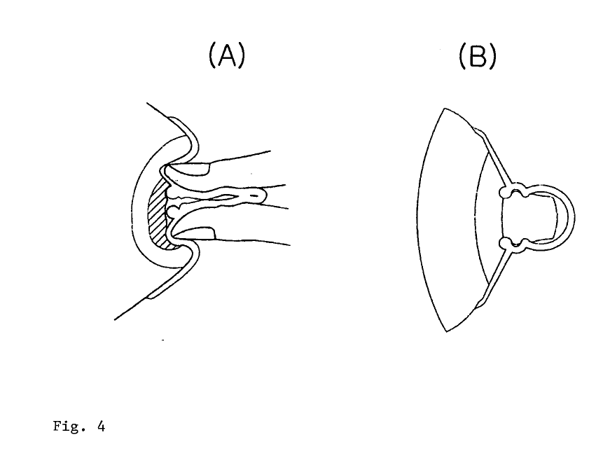

FIGS. 4A and 4B show an operation of the corrector for an inverted nipple in accordance with the present invention.

The corrector is disposed on the breast of the user so that the center of the nipple mould 10 corresponds to the center of the nipple 52 of the user. Then, the nipple mould 10 is strongly pressed by fingers so that air can be withdrawn from the nipple mould 10, thereby producing a vacuum state within the nipple mould 10.

The pressing element 21 of the corrector in which the nipple mould 10 is strongly pressed by the fingers contacts the nipple 52 and simultaneously presses the nipple 52. Then, the fingers are gradually loosened from the nipple mould 10. Thereby, the inverted nipple 52 is gradually drawn out from the breast and then sucked into the nipple mould 10 by means of a pressure difference between the atmosphere and the inside of the nipple mould 10 and an elastic restoring force of the corrector made of silicon.

The sucked and protruded nipple 52 into the nipple mould 10 is fixedly held by the pressing element 21 and the supporting element 22, and is further fixedly supported by the hollow core 23 therebetween.

Further, the conical-shaped absorption part 30 and the inclined end 31 of the absorption part 30 at the designated obtuse angle improve the close contact force of the corrector with the breast, thereby maintaining a sealing effect within the corrector for a long time.

When the corrector is separated from the breast, the inclined end 31 of the absorption part 30 is slightly lifted up. Then, since the pressure within the nipple mould part 10 becomes equal to the atmospheric pressure, the corrector for an inverted nipple is easily separated from the user's breast.

Inverted nipples cause a difficulty in natural breastfeeding after parturition, and the inverted nipples under an unsanitary condition are easily affected by breast diseases such as mastitis. Further, the inverted nipples are bad in appearance and induce a psychological complex to women.

The inverted nipples were conventionally corrected by a surgical operation. However, a more stable and reliable operation, which can be applied to all patients and does not cause any lactation trouble after parturition, has not been yet developed.

Further, an inverted nipple easily protruded from the breast by means of a small stimulus is not the subject of a surgical operation.

As apparent from the above description, the present invention provides a corrector for any types of inverted nipples, which is simply worn by the user's breast always at everyday life. The corrector for an inverted nipple of the present invention is not exposed and protruded to the outside, thereby giving a freedom of wearing clothing to users.

Particularly, the corrector for an inverted nipple of the present invention comprises an improved neck part, thereby improving its close contact force with the breast, maintaining the contact state for a long time, and preventing its separation from the breast.

Further, the corrector for an inverted nipple of the present invention is inexpensive, and easily carried and stored, thereby being widely used by women with inverted nipples.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A corrector for an inverted nipple, comprising a nipple mould for receiving the nipple, a narrow neck part for maintaining a pressure of the inside of the nipple mould, and an absorption part for contacting the breast so as to maintain the vacuum state of the corrector,
wherein the narrow neck part includes a supporting element, a hollow core, and a pressing element so as to improve a holding force of the nipple by the nipple mould, the supporting element is formed as a protrusion protruding from the inner circumference of the hollow core having a designated depth, the pressing element is formed as a protrusion protruding from the inner circumference of the hollow core having a designated depth thicker than that of the supporting element, and the hollow core is disposed between the supporting element and the pressing element.

2. The corrector for an inverted nipple as set forth in claim 1, being made of silicon or elastic material.

3. The corrector for an inverted nipple as set forth in claim 1, wherein the absorption part is conical-shaped, and a thickness and a length of the absorption part are controllable.

4. The corrector for an inverted nipple as set forth in claim 3, wherein the absorption part includes an inclined end at a designated obtuse inside angle.
